(19) United States
(12) Patent Application Publication
(10) Pub. No.: US 2004/0030483 A1
(43) Pub. Date: Feb. 12, 2004

(54) Method for controlling the speed of a vehicle

(76) Inventor: Christian Muehlbauer, Echterdingen (DE)

Correspondence Address: Walter Ottesen, Patent Attorney, P.O. Box 4026, Gaithersburg, MD, 20885-4026, US

(21) Appl. No.: 10/632,837

(22) Filed: Aug. 4, 2003

(30) Foreign Application Priority Data
Aug. 2, 2002 (DE) 102 35 363.8

(51) Int. Cl. B60T 8/24

(52) U.S. Cl. 701/93; 701/72

(57) ABSTRACT

In a method for the control of the speed of a vehicle (1), the desired speed remains stored also after a deactivation of the control for a resumption of the control. For the resumption, the type of the roadway (5, 10, 15) currently driven upon by the vehicle is determined with respect to a maximum permissible speed and the desired speed is limited to this maximum permissible speed with the resumption of the control.

### BACKGROUND OF THE INVENTION

It is already known that the last desired speed remains stored when a road speed control of a vehicle, such as a tempomat, is deactivated during travel. After a renewed activation of the road speed control via a “driver-command resume”, the last used and stored desired speed is again driven to. Accordingly, if during expressway travel, a desired speed of 130 km/h was stored, then this desired speed would remain stored after driving off of the expressway and during a subsequent drive on a secondary road. The last stored desired speed of 130 km/h would be driven to when a key “resume” is pressed for the renewed activation of the drive speed control.

### SUMMARY OF THE INVENTION

The method for controlling the speed of a vehicle according to the invention affords the advantage with respect to the foregoing that, for the resumption of the control, the type of roadway just then driven by the vehicle is determined with respect to a maximum permissible speed and that the desired speed for the resumption of the control is limited to this maximum permissible speed. In this way, the speed, which is stored with the deactivation of the road speed control, can be adapted to the maximum speed permissible for the particular type of roadway when resuming the road speed control. Here, the situation is prevented when resuming the road speed control that the vehicle is accelerated to a speed which is too high.

It is especially advantageous when the type of roadway, which is driven on by the vehicle, is determined by means of a navigation system. In this way, the type of roadway driven on by the vehicle is especially reliably determined.

It is also advantageous when the type of roadway actually driven on by the vehicle is determined in dependence upon a curve radius of the roadway. In this way, the instantaneous type of roadway can be especially reliably determined without a navigation system being required.

The curve radius can be especially easily determined from a comparison of at least two wheel speeds of the vehicle and/or by means of a steering angle sensor.

The type of roadway driven upon by the vehicle can be determined especially easily in dependence upon the instantaneous road speed especially when, as a criterion, the road speed is determined which is maximally reached since at least a pregiven time after deactivation of the control.

### BRIEF DESCRIPTION OF THE DRAWINGS

The invention will now be described with reference to the drawings wherein:

FIG. 1 is a block circuit diagram of a road speed control of a motor vehicle;

FIG. 2 is a flowchart for explaining the sequence of the method of the invention;

FIG. 3 is a flowchart for explaining the sequence in the determination of the actual type of roadway according to a first embodiment of the invention;

FIG. 4 is a flowchart showing the sequence in the determination of the actual type of roadway according to a second embodiment;

FIG. 5 is a flowchart for explaining the sequence for determining the actual type of roadway according to a third embodiment; and,

FIG. 6 is an exemplary course of the speed of a vehicle as a function of time for explaining the method of the invention.

### DESCRIPTION OF THE PREFERRED EMBODIMENTS OF THE INVENTION

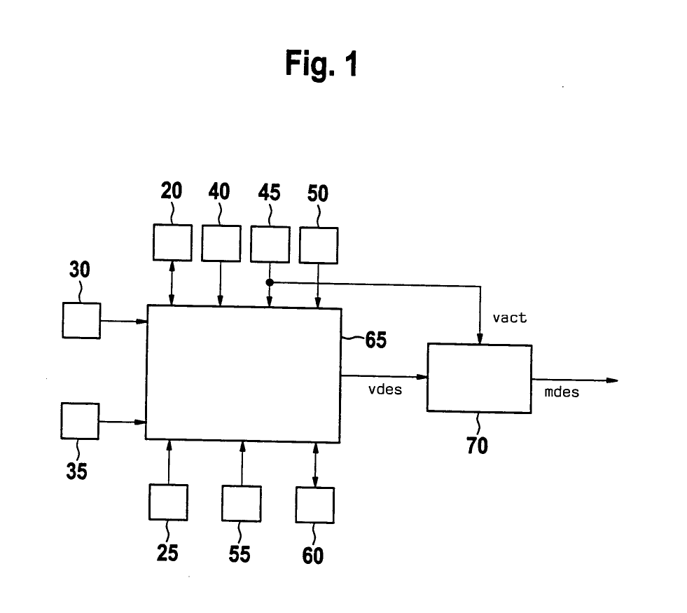

In FIG. 1, reference numeral 70 identifies a road speed control of a vehicle having a drive unit which, for example, has an internal combustion engine or an electric motor or is based on a drive concept alternative thereto. The internal combustion engine can, for example, be a spark-ignition engine or a diesel engine. A desired speed vdes and an actual speed vact are supplied to the road speed control 70. The road speed control 70 forms a desired value for an output quantity of the drive unit of the vehicle with the objective that the actual speed vact is to track as closely as possible the desired speed vdes. The output quantity of the drive unit can, for example, be a torque. The torque can be a wheel output torque, a transmission output torque or an engine output torque. The desired value, which is formed by the road speed control 70 for the tracking by the actual speed vact, is then a desired torque mdes. The output quantity can also be the output power of the drive unit or any output quantity of the drive unit derived from a torque. In the following, it is assumed by way of example that the road speed control 70 forms the desired torque mdes, for example, for the engine output torque in dependence upon the difference between the desired speed vdes and the actual speed vact. The desired torque mdes is then transmitted from the road speed control 70 into an engine control (not shown). The engine control converts the desired torque mdes into an engine output torque with the aid of at least one actuating quantity, for example, the air charge and/or the ignition angle in the case of a spark-ignition engine or the fuel injection in the case of a diesel engine. Here it should be assumed by way of example that the drive unit includes an internal combustion engine.

The desired speed vdes is pregiven by an arrangement 65 and is transmitted to the road speed control 70. The arrangement 65 can also be characterized as a desired speed determination unit. The desired speed determination unit 65 is connected to an operator-controlled element 50, for example, a lever of a tempomat (vehicle-speed controller). The desired speed determination unit 65 can be activated via the tempomat lever 50 for forming the desired speed vdes. Via the tempomat lever 50, the driver of the vehicle can, in a manner known per se, input the desired speed vdes and can increase or reduce this speed. With the actuation of a vehicle brake 55, the desired speed determination unit 65 is deactivated. In this case, no desired speed vdes or a desired speed vdes equal to zero is transmitted to the road speed control 70 and the road speed control 70 is thereby deactivated. If the desired speed vdes, which is transmitted by the desired speed determination unit 65 to the road speed control 70, is greater than zero, then the road speed control 70 is activated thereby.

The actual speed vact is supplied to the road speed control 70 by a road speed detection unit 45. The road speed detection unit 45 measures the speed of the vehicle as a road speed sensor in a manner known per se. The road speed detection unit 45 can also be connected to the desired speed determination unit 65. In addition, or alternatively, the desired speed determination unit 65 can be connected to a navigation unit 20. In this case, the desired speed determination unit 65 can also be connected to a location module 40, for example, a global positioning system (GPS) receiver. Additionally, or alternatively, the desired speed determination unit 65 can be connected to several wheel speed sensors 30 to 35 which each detects the speed of the wheel of the vehicle assigned thereto in a manner known per se. Additionally, or alternatively, the desired speed determination unit 65 can be connected to a steering wheel sensor 25 which detects the steering wheel angle of the vehicle in a manner known per se. Additionally, or alternatively, the desired speed determination unit 65 can be connected to a timer element 60 which has a pregiven time constant or a time constant is given thereto by the desired speed determination unit 65. The time constant of the timer element 60 can also be pregiven by the driver via an operator-controlled element not shown in FIG. 1. After setting the timer element 60 by the desired speed determination unit 65, the timer element 60 is started and generates a stop signal after the elapse of the time defined by the time constant. The stop signal is supplied to the desired speed determination unit 65.

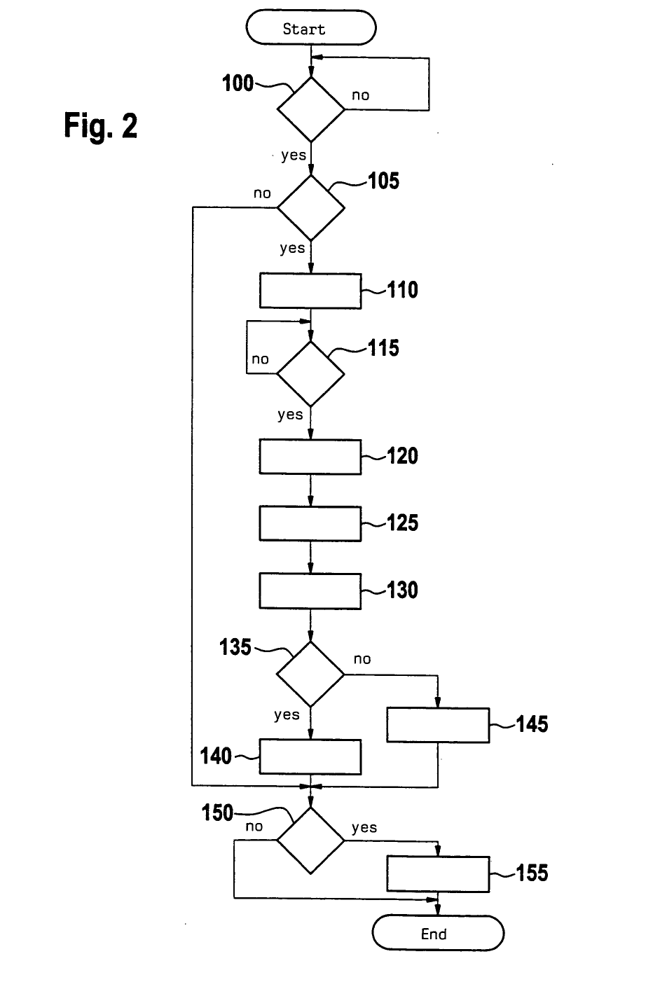

The method of the invention will now be explained in greater detail with respect to FIG. 2.

After the start of the program, the desired speed determination unit 65 checks at program point 100 as to whether an activation signal in the form of a pregiven desired speed vdes greater than zero is present from the operator-controlled element 50. If this is the case, then the program branches to a program point 105. Otherwise, the program branches back to program point 100. At program point 105, the desired speed determination unit 65 checks whether the vehicle brake 55 received a deactivation signal, that is, whether the vehicle brake 55 was actuated. If this is the case, then there is a branching to program point 110; otherwise, the program branches to a program point 150. At program point 110, the desired speed determination unit 65 causes a storage of the last valid desired speed vdes in a memory (not shown in FIG. 1 and assigned to the desired speed determination unit 65) and sets the desired speed vdes, which is outputted to the road speed control 70, to zero in order to deactivate the driving speed control 70. The speed value, which is stored in the memory, is thereby the desired speed vdes, which is determined last in advance of the deactivation of the driving speed control 70, and is identified in the following also as a stored desired speed vdesg. Thereafter, there is a branching to a program point 115. At program point 115, the desired speed determination unit 65 checks whether the driver wants a resumption of the control of the speed of the vehicle by actuating the tempomat lever 50, that is, whether the drive speed control 70 should be activated again. If this is the case, then the program branches to a program point 120; otherwise, the program branches back to program point 115.

At program point 120, the desired speed determination unit 65 detects the type of the roadway actually driven upon by the vehicle. This detection of the actual type of roadway is described hereinafter with respect to three different embodiments. Thereafter, the program branches to program point 125.

At program point 125, the desired speed determination unit 65 calculates the maximum permissible speed for the actual type of roadway. Thereafter, the program branches to program point 130.

At program point 130, the desired speed determination unit 65 compares the last valid desired speed vdesg, which is stored in the memory, to the maximum permissible speed determined for the actual type of roadway. Thereafter, the program branches to program point 135. At program point 135, the desired speed determination unit 65 checks whether the stored desired speed vdes is greater than the maximum permissible speed for the actual type of roadway. If this is the case, there is a branching of the program to program point 140; otherwise, the program branches to a program point 145.

At program point 140, the desired value determination unit 65 forms the desired speed vdes, which is to be outputted to the road speed control 70 for the resumption of the control of the speed of the vehicle in that the control sets this desired speed vdes equal to the maximum speed permissible for the actual type of roadway. Thereafter, the program branches to program point 150.

At program point 145, the desired speed determination unit 65 forms the desired speed vdes, which is to be outputted to the road speed control 70 for the resumption of the control of the speed of the vehicle, in that the control sets this desired speed vdes equal to the stored desired speed vdesg. Thereafter, the program branches to program point 150.

At program point 150, the desired speed determination unit 65 checks whether the desired speed vdes, which is to be outputted to the road speed control 70, should be changed because of an actuation of the tempomat lever 50. If this is the case, the program branches to a program point 155; otherwise, there is a movement out of the program.

At program point 155, the desired speed determination unit 65 forms anew the desired speed vdes, which is to be outputted to the road speed control 70, while considering the input and the tempomat lever 50. Thereafter, there is a movement out of the program.

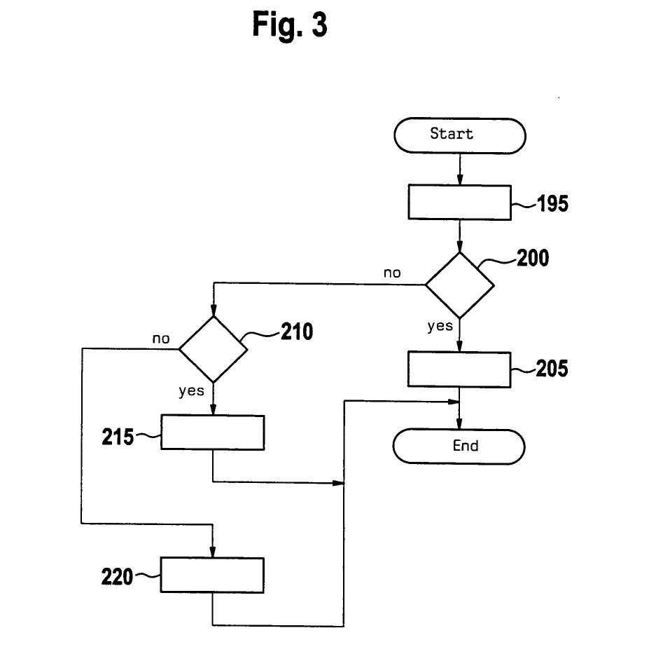

In FIG. 3, a flowchart for determining the actual type of roadway is shown in accordance with a first embodiment. The program is started when program point 120 of FIG. 2 is reached. The desired speed determination unit 65 evaluates the signal of the steering wheel sensor 25 and/or the signals of the wheel speed sensors 30 to 35. By comparing the road speeds of the two wheels of a common axis, the instantaneous curve radius of the roadway can be determined. For this purpose, the signals of the wheel speed sensors of the two wheels of a common axis of the vehicle are evaluated. In addition, or alternatively, the curve radius can be determined from the steering angle determined by the steering angle sensor 25. The computation of the curve radius takes place in a manner known per se from the comparison of the wheel speeds of two wheels of a common axis of the vehicle or from the steering angle. For the determination of the actual roadway type, it can be advantageous to detect the curve radius over a pregiven time after the resumption of the control of the speed of the vehicle, which is signalized by the driver via the tempomat lever 50 and to apply the minimum radius, which occurs during this pregiven time, for determining the actual type of roadway. The pregiven time can be measured by means of a timer element 60 and corresponds to the time constant of the timer element 60. Here, it is purposeful to select the pregiven time and therefore the time constant of the timer element 60 as short as possible in order to not to delay too long the resumption of the control of the speed based on the determination of the actual type of roadway.

The described determination of the minimum actual curve radius, which occurs during the pregiven time, takes place in the sequence plan of FIG. 3 at a program point 195. Thereafter, the program branches to program point 200.

At program point 200, the desired speed determination unit 65 checks whether the minimum curve radius is greater than a first pregiven value (for example, 200 m) during the pregiven time. If this is the case, then the program branches to program point 205; otherwise, the program branches to program point 210.

At program point 205, the desired speed determination unit 65 recognizes the actual roadway as an expressway and sets the permissible maximum speed to infinity. Thereafter, there is a movement out of the program and the sequence of FIG. 2 is continued at program point 130.

At program point 210, the desired speed determination unit 65 checks whether the minimum curve radius is greater than a second pregiven value (for example, 10 m) during the pregiven time and whether, simultaneously, the actual speed vact does not exceed a first speed threshold during the pregiven time (for example, the maximum speed of 100 km/h permitted on secondary roads in Germany. If this is the case, then the program branches to a program point 215; otherwise, the program branches to a program point 220.

At program point 215, the desired speed determination unit 65 recognizes the actual roadway as a secondary road and sets the permissible maximum speed to the first speed threshold. Thereafter, there is a movement out of the program and the sequence diagram of FIG. 2 is continued at program point 130.

At program point 220, the desired speed determination unit 65 recognizes the actual roadway as a street in a town. This is additionally confirmed in that the desired speed determination unit 65 detects during the pregiven time no actual speed vact above a second speed threshold which corresponds for example, to the maximum speed of 50 km/h permitted in towns in Germany. In this way, the desired speed determination unit 65 sets the permissible maximum speed at program point 220 to the second speed threshold. Thereafter, there is a movement out of the program and the sequence diagram of FIG. 2 is continued at program point 130.

Alternatively, the type of actual roadway can be determined during the pregiven time solely on the basis of the minimum curve radius. The described check of the actual speed is then not carried out because the curve radius itself is already an adequate criterion for determining the actual type of roadway. For example, in a town, curves having an angle of 90° are possible which have a curve radius below the second pregiven value of 10 m. Expressway curves are designed for speeds above, for example, 130 km/h and therefore have a curve radius greater than the first pregiven value of 200 m.

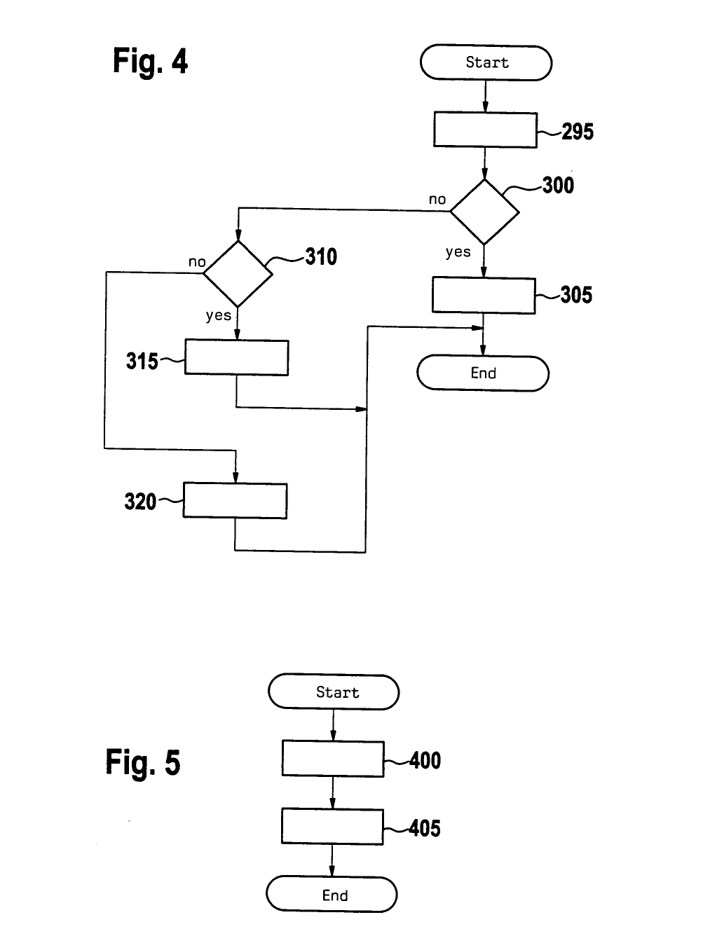

Furthermore, and alternatively, the actual roadway type can also be determined only with the aid of the determined actual speed vact during the pregiven time as shown in the sequence diagram of FIG. 4. The sequence diagram of FIG. 4 is started in accordance with FIG. 2 when reaching the program point 120. After the start of the program of FIG. 4, the actual speed vact is detected during the pregiven time by the desired speed determination unit 65 at program point 295 and the maximum of the actual speed vact during the pregiven time is determined. Thereafter, the program branches to a program point 300. At program point 300, the desired speed determination unit 65 checks whether the maximum actual speed, which occurs during the pregiven time, is greater than the first speed threshold. If this is the case, then the program branches to program point 305; otherwise, the program branches to program point 310.

At program point 305, the desired speed determination unit 65 detects the actual roadway type as an expressway and sets the permissible maximum speed to infinity. Thereafter, there is a movement out of the program and the sequence diagram of FIG. 2 is continued at program point 130.

At program point 310, the desired speed determination unit 65 checks whether the maximum actual speed, which occurs during the pregiven time, is greater than the second speed threshold. If this is the case, then the program branches to program point 315; otherwise, the program branches to program point 320.

At program point 315, the desired speed determination unit 65 detects the actual type of roadway as a secondary road and sets the permissible maximum speed to the first threshold value. Thereafter, there is a movement out of the program and the sequence diagram of FIG. 2 is continued at program point 130.

At program point 320, the desired speed determination unit 65 detects the actual roadway as a roadway in a town and sets the maximum permissible speed to the second threshold value. Thereafter, there is a movement out of the program and the sequence diagram of FIG. 2 is continued at program point 130.

For an alternative embodiment, the desired speed determination unit 65 can set the maximum permissible speed at program point 125 in accordance with the sequence diagram of FIG. 2 even to the actual speed, which occurs maximally during the pregiven time and can thereby adapt as best as possible to the speed selected by the driver.

If the maximum permissible speed is determined only in dependence upon the actual speed vact of the vehicle in the manner described, then no steering angle sensor 25 and also no wheel speed sensor 30 to 35 is required in order to limit the desired speed vdes in the resumption of the control of the speed of the vehicle to the maximum permissible speed in dependence upon the type of actual roadway driven upon by the vehicle.

In order not to lose any time in the resumption of the control of the speed of the vehicle because of the determination of the type of actual roadway driven upon by the vehicle, the type of actual roadway, which is driven upon by the vehicle, can also be determined already after deactivation of the road speed control 70 in the manner described and can be actualized up to resumption of the control of the speed of the vehicle, for example, at regular time intervals so that, with the resumption of the control of the speed of the vehicle, the actual type of roadway and the maximum permissible speed corresponding thereto is already known in the desired speed determination unit 65. The shorter the time intervals are selected for the regular actualization of the type of roadway, the more precisely the roadway type is known, which is present at the time point of the resumption of the control of the speed of the vehicle, for the determination of the maximum permissible speed at program point 125 in accordance with the sequence diagram of FIG. 2.

In FIG. 5, a sequence diagram for a further alternate embodiment for determining the actual type of roadway is shown. The program of FIG. 5 is started when reaching the program point 120 of the sequence diagram of FIG. 2. Thereafter, the program branches to program point 400. At program point 400, the desired speed determination unit determines the actual location of the vehicle with the aid of a positioning module 40. The desired speed determination unit 65 then outputs the actual location of the navigation unit 20. Based on the actual location of the vehicle, the navigation unit 20 identifies the actual street driven upon and transmits information back as to the roadway type to the desired speed determination unit 65, that is, the navigation unit 20 announces to the desired speed determination unit 65 whether the actual roadway driven upon is an expressway, a secondary road or a street in a town. It can also be provided that the positioning module 40 is connected directly to the navigation unit 20 so that the desired speed determination unit 65 for determining the actual type of roadway transmits only an inquiry to the navigation unit 20 which, thereupon, inquires of the positioning module 40 as to the actual position and, in dependence upon the actual position, determines the actual type of roadway and transmits this back to the desired speed determination unit 65. Thereafter, the program branches to program point 405.

At program point 405, the desired speed determination unit 65 sets the maximum permissible speed to a value which is assigned to the determined actual roadway type and is stored, for example, in a memory (not shown in FIG. 1) which is assigned to the desired speed determination unit 65. In this way, the desired speed determination unit 65 can, in the case of an actual roadway detected as an expressway, set the maximum permissible speed to infinity and, in the case of an actual roadway recognized as a secondary road, set the maximum permissible speed to 100 km/h and, in the case of an actual roadway recognized as a street through a town, set the maximum permissible speed to 50 km/h. Thereafter, there is a movement out of the program and the sequence diagram of FIG. 2 is continued at program point 130.

The determination of the actual roadway type by means of the navigation unit 20 can be carried out in the manner described either right after the deactivation of the road speed control 70 or only with the detection of a resumption of the control of the speed of the motor vehicle initiated by the driver at the tempomat lever 50.

The described examples proceeded from three different maximum permissible speeds depending upon whether the actual roadway type is an expressway, a secondary road or a street through a town. The invention is not limited to these types of roadways; rather, the invention is applicable to any type of roadway and corresponding maximum permissible speeds in a corresponding manner. The maximum permissible speeds for the individual roadway types can also be assigned to specific countries in the desired speed determination unit 65 or in the assigned memory. The driver can input, for example, at an operator-controlled element (not shown in FIG. 1) in which country the vehicle is just then located so that the corresponding values for the maximum permissible speeds for the limitation of the desired speed vdes are available for the resumption of the control of the speed of the vehicle.

To increase the reliability of the limiting of the desired speed vdes to the maximum permissible speed in dependence upon the actual roadway type for a resumption of the control of the speed of the vehicle, it can also be provided to use several or all of the above-mentioned algorithms to determine the actual roadway type and to use the minimum of the maximum permissible speeds as the resulting maximum permissible speed for limiting the desired speed vdes. These maximum permissible speeds as supplied by the individual algorithms according to the different embodiments. In this way, in the manner described, with the resumption of the control of the speed of the vehicle, either the desired speed vdes is set to the last used stored desired speed vdesg in advance of deactivation of the control (if the resulting maximum permissible speed for the actual roadway type is not exceeded) or, otherwise, the desired speed vdes is limited to this resulting maximum permissible speed.

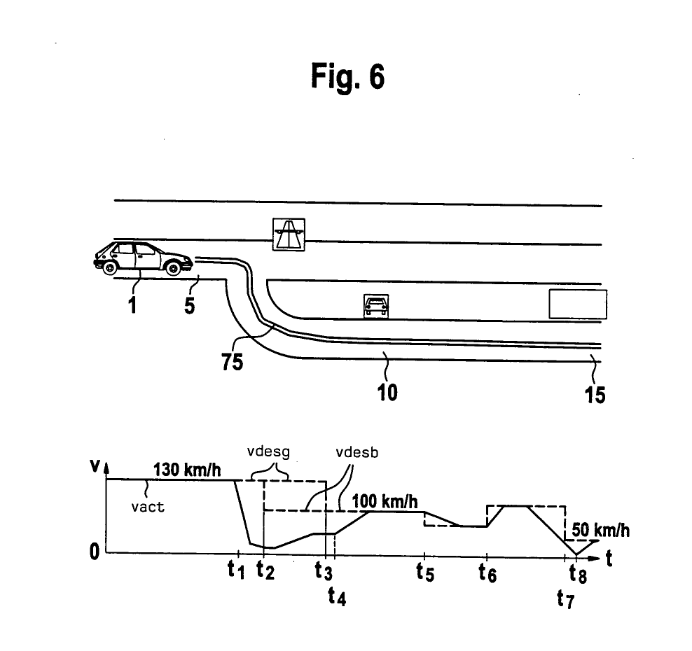

According to FIG. 6, a speed-time diagram is shown wherein the speed (v) is plotted as a function of time (t). A course of a roadway, which is passed over by the vehicle 1, is assigned to this speed trace as a function of time (t). In this example, the vehicle 1 includes the desired speed determination unit 65 of FIG. 1 wherein the method of the invention is implemented in the manner described using hardware and/or software. The roadway itself is characterized in FIG. 6 by reference numeral 75. The actual speed vact of the vehicle is shown as a solid line in the speed-time diagram. Up to a first time point t₁, the vehicle 1 travels on an expressway 5 with activated road speed control 70 and a pregiven desired speed of 130 km/h. The actual speed vact of the vehicle 1 is likewise approximately 130 km/h because of the road speed control 70. The vehicle 1 leaves the expressway 5 at the first time point t₁ and the driver of the vehicle 1 actuates the brake 55. In this way, the actual speed vact drops and the road speed control 70 is deactivated. The last valid value for the desired speed vdes of 130 km/h is stored and is therefore available for a resumption of the control of the speed of the vehicle 1. The stored desired speed vdesg is shown by a broken line from the first time point t₁ and is 130 km/h. At a second time point t₂, which follows the first time point t₁, the desired speed determination unit 65 recognizes, for example, a curve radius between the first pregiven value and the second pregiven value and therefore a secondary road based on the determination of the actual roadway type started after deactivation of the control of the speed of the vehicle 1. Additionally, or alternatively, the desired speed determination unit 65 can recognize at the second time point t₂ by means of the navigation unit 20 that the vehicle is now on a secondary road 10. Accordingly, the desired speed determination unit 65 limits the stored desired speed vdesg to a limited desired speed vdesb in the amount of the maximum permissible speed of 100 km/h which is permitted for the secondary roadway 10 and stores this value in lieu of the previously stored desired speed vdesg for a resumption of the control of the speed.

If the type of the actual roadway is determined in accordance with the algorithm of FIG. 4 exclusively based on the trace of the actual speed vact in the pregiven time after deactivation of the control of the speed at the first time point t₁, then, with the method of FIG. 4, it can also be provided to use the mean value occurring in this pregiven time in lieu of the maximum speed value of the actual speed vact which occurs in the pregiven time. This can be advantageous if the desired speed vdes was selected at the first time point t₁ greater than the first speed threshold of 100 km/h so that after deactivation of the control of the speed because of a brake intervention, the actual speed vact is still greater than the first speed threshold and, for this reason, the expressway is detected as the actual roadway even though the vehicle 1 is already on a secondary road 10. In the example of FIG. 6, precisely this case occurs, that is, after deactivation of the control of the speed at the first time point t₁, the actual speed vact is still greater than the first speed threshold of 100 km/h. In this case, the evaluation of the mean value of the actual speed vact in the pregiven time after deactivation of the control of the speed of the vehicle 1 would be more purposeful and can generally be provided when using the method of FIG. 4. In this example, the pregiven time extends from the first time point t₁ up to a third time point t₃ following the second time point t₂. In this pregiven time, the mean value of the actual speed vact lies between the first speed threshold of 100 km/h and the second speed threshold of 50 km/h. For this reason, at the third time point t₃, the actually used roadway is recognized as a secondary roadway at the third time point t₃ when using the sequence plan of FIG. 4 and the maximum permissible speed is set to the first speed threshold of 100 km/h so that the limiting of the stored desired speed vdesg to the limited desired speed vdesb takes place in this case only at the third time point t₃ as likewise shown by the broken line in FIG. 6. At a fourth time point t₄ following the third time point t₃, the driver causes the vehicle 1 to resume the control of the speed of the vehicle 1 with the actuation of the tempomat lever 50 so that the road speed control 70 is again activated at the fourth time point t₄ and, as the desired speed, the limited desired speed vdesb from the memory is used, that is, the first speed threshold of 100 km/h is pregiven as the desired speed.

For this reason, the actual speed vact approaches the limited desired speed vdesb from the fourth time point t₄ because of the road speed control 70. At a fifth time point t₅, which follows the fourth time point t₄, the driver of the vehicle 1 changes the desired speed in the tempomat lever 50 in that the driver drops the desired speed as shown by the broken line in FIG. 6. This is the normal operation of the road speed control, that is, the change of the desired speed vdes by the driver at the tempomat lever 50. In this way, the actual speed vact drops after the fifth time point t₅ to the new desired value vdes and the actual speed reaches the desired speed in advance of the sixth time point t₆ which follows the fifth time point t₅. At the sixth time point t₆, the driver of the vehicle 1 increases the desired speed vdes with a corresponding actuation of the tempomat lever 50 as shown by the broken line in FIG. 6 so that, from the sixth time point t₆ on, the actual speed vact again increases in order to reach the new desired speed in advance of the seventh time point t₇ which follows the sixth time point t₆. In advance of the seventh time point t₇, the driver recognizes coming close to a town and brakes the vehicle so that the road speed control 70 is again deactivated. The desired speed which was valid up to now is again stored. At time point t₇, the desired speed determination unit 65 recognizes in the manner described a street through a town 15 as being the roadway type actually driven upon by the vehicle 1 and therefore limits the stored desired speed to the second speed threshold, in this example, 50 km/h which, for a resumption of the control of the speed of the vehicle 1, is supplied to the road speed control 70 as a new desired speed at an eighth time point t₈ following the seventh time point t₇ and is approached by the actual speed vact.

Alternatively to using the maximum actual speed vact or the mean value of the actual speed vact in the pregiven time after deactivation of the control of the speed in the sequence plan of FIG. 4, the then current instantaneous actual speed vact at the time point of the resumption of the control of the speed of the vehicle can be used and, in the manner described, can be compared to the first speed threshold and/or to the second speed threshold for determining the current roadway type. The use of the instantaneous actual speed vact in lieu of the actual speed vact viewed over the pregiven time affords the advantage that the current roadway type can be directly recognized with the least amount of time. However, this method is less reliable than the viewing over the pregiven time. Correspondingly, with the algorithm of FIG. 3, the current curve radius can be viewed in lieu of the trace of the curve radius as a function of the pregiven time in order to determine the current roadway type. In the speed comparison, carried out in accordance with the method of FIG. 3, either the maximum or the mean value of the actual speed vact can be used during the pregiven time after deactivation of the control of the speed or even the current speed present at the time point of the resumption of the control of the speed.

The time for observing the actual speed vact and/or the curve radius after deactivation of the control of the speed can, as described, be fixedly pregiven or can be pregiven by the driver. The observation of the actual speed vact and/or of the curve radius can, however, take place from the deactivation of the control of the speed also beyond the pregiven time up to the resumption of the control of the speed, that is, in the example of FIG. 6, in lieu of up to the third time point t₃, up to the fourth time point t₄. In the evaluation of the curve radius for determining the roadway type, the time span between the first time point t₁ and the second time point t₂ was selected as the pregiven time in the example of FIG. 6. For this pregiven time span, likewise the speed can be evaluated in accordance with the method described according to FIG. 3 as additional criterion in the manner known per se in order to determine that the actual speed vact between the first time point t₁ and the second time point t₂ lies on average between the first speed threshold and the second speed threshold so that the limiting of the desired speed to the first speed threshold is supported via the additional speed observation.

It is understood that the foregoing description is that of the preferred embodiments of the invention and that various changes and modifications may be made thereto without departing from the spirit and scope of the invention as defined in the appended claims.

What is claimed is:

1. A method of controlling the speed of a vehicle, the method comprising the steps of:
maintaining a desired speed for a resumption of the control stored in a memory after a deactivation of the control;
for said resumption of said control, determining the type of roadway upon which said vehicle is traveling with respect to a permissible maximum speed; and,
limiting said desired speed to said permissible maximum speed when resuming said control.

2. The method of claim 1, wherein a navigation device is used to determine said type of roadway.

3. The method of claim 1, wherein said type of roadway is determined in dependence upon a curve radius of said roadway.

4. The method of claim 3, wherein said curve radius is determined from a comparison of at least two wheel speeds of said vehicle and/or with a steering angle sensor.

5. The method of claim 1, wherein said type of roadway is determined in dependence upon the actual driving speed.

6. The method of claim 1, wherein said type of roadway is determined in dependence upon a maximum driving speed reached since at least a pregiven time after deactivation of said control.
